(19) United States
(12) Patent Application Publication
(10) Pub. No.: US 2019/0392080 A1
(43) Pub. Date: Dec. 26, 2019

(54) METHOD AND COMPUTING DEVICE FOR FILTERING A SET OF RECORDS ON A USER INTERFACE

(71) Applicant: WORKIVA INC., Ames, IA (US)

(72) Inventors: Edward Ly, Jewell, IA (US); Kyle James McMorrow, Ames, IA (US); Kevin Curtis Walker, Ames, IA (US); Taylor Marie Wertzberger, Ames, IA (US)

(21) Appl. No.: 16/014,645

(22) Filed: Jun. 21, 2018

(51) Int. Cl. G06F 17/30; G06F 3/0482

(52) U.S. Cl. CPC G06F 17/30867; G06F 3/0482; G06F 17/30554; G06F 17/30572

(57) ABSTRACT

A method for filtering a set of records on a user interface involves displaying a set of records, each record of the set comprising a first field and a second field; removing, from the displayed set, one or more records according to a filter of the first field, thereby leaving a subset of the set of records displayed; displaying filters for the second field; and for at least one of the displayed filters, visually indicating that, due to a currently-applied filter, the at least one displayed filter does not apply to any of the records of the subset.

### TECHNICAL FIELD

The disclosure relates generally to user interface optimization and, more particularly, to a method and computing device for filtering a set of records on a user interface.

### BACKGROUND

Software packages (such as spreadsheet programs) that present data in tabular form often include some type filtering function, whereby the user can select a column and filter according to the contents of that column. For example, in a spreadsheet containing addresses, a user might only want to see addresses in New York state, and would filter out the non-New York addresses by clicking on the column header for “State” and only checking the box next to “New York” in the list of possible filters. Filtering on multiple columns is not as simple, however. One complication is that by applying one filter, the user loses visibility into other possible filters. For example, by applying the New York filter to a list of addresses, the user is no longer able to see filters for “City” that lie outside of New York.

### DRAWINGS

While the appended claims set forth the features of the present techniques with particularity, these techniques may be best understood from the following detailed description taken in conjunction with the accompanying drawings of which:

FIG. 1 is a block diagram illustrating an example networking environment in which various embodiments of the disclosure may be employed.

FIG. 2 is a block diagram of a computing device, according to an embodiment.

FIGS. 3A-3J illustrate a user interface implemented according to an embodiment.

### DESCRIPTION

According an embodiment, a method for filtering a set of records on a user interface involves displaying a set of records, each record of the set comprising a first field and a second field; removing, from the displayed set, one or more records according to a filter of the first field, thereby leaving a subset of the set of records displayed; displaying filters for the second field; and for at least one of the displayed filters, visually indicating that, due to a currently-applied filter, the at least one displayed filter does not apply to any of the records of the subset.

In an embodiment, displaying a set of records includes displaying a table having a row for each record of the set, a first column for the first field and a second column for the second field.

According to an embodiment, the method further includes receiving a user selection of the filter of the first field via a selection menu.

In an embodiment, the method further includes receiving a user selection of the filter of the first field, launching a database query based on the filter of the first field, and displaying the results of the query.

According to an embodiment, the visual indication is carried out by rendering the name of the filter that does not apply in a font style, font color, or font size that is different from other displayed filters.

In an embodiment, the visual indication is carried out by listing the name of the filter in a sublist that is distinct from filters that do apply to one or more records of the subset.

According to an embodiment, removing one or more records from the displayed set involves removing, from the displayed set, all records in which the first field contains a value (e.g., text string or numerical value) specified by the filter.

In an embodiment, removing one or more records from the displayed set involves removing, from the displayed set, all records in which the first field does not contain the value (e.g., text string or numerical value) specified by the filter.

According to an embodiment, the method further involves visually indicating that the first filter is a currently-applied filter.

In an embodiment, a method for filtering a set of records on a user interface involves executing a query of a database to obtain a set of records; displaying the set of records; applying a first filter to the displayed set of records; removing, from the displayed set, all records to which the first filter applies; re-executing the query of the database to obtain an updated set of records, wherein the updated set does not include any records to which the first filter would apply; displaying a plurality of filter labels, including a label for the first filter; and visually indicating that the first filter does not apply to any records of the set but has been previously applied.

According to an embodiment, visually indicating that the first filter does not apply to any records of the set comprises visually indicating that the first filter has been previously applied to a report generated using the query.

In an embodiment, a method for filtering a set of records on a user interface involves displaying a set of records, each record of the set comprising a first field and a second field; receiving a user selection of a plurality of filters of the first field; removing, from the displayed set, one or more records according to the plurality of filters, thereby leaving a subset of the set of records displayed; displaying a plurality of filters for the second field; and for at least one of the displayed filters of the second field, visually indicating that the displayed filter of the second field does not apply to any of the records of the subset due to a currently-applied filter, wherein the currently-applied filter is a filter of the plurality of selected filters of the first field.

According to an embodiment, the method further involves visually indicating which of the plurality of selected filters of the first field is the currently-applied filter.

In an embodiment, the displayed set of records is the result of a database query and the method further involves receiving a user entry of a new filter that does not apply to any of the set of records and visually indicating that the new filter does not apply to any of the set of records.

According to an embodiment, a computing device obtains the set of records without having to communicate with a server (e.g., obtains the records as a result of a query to a locally-maintained database) and carries out the various filtering operations on the obtained set of records.

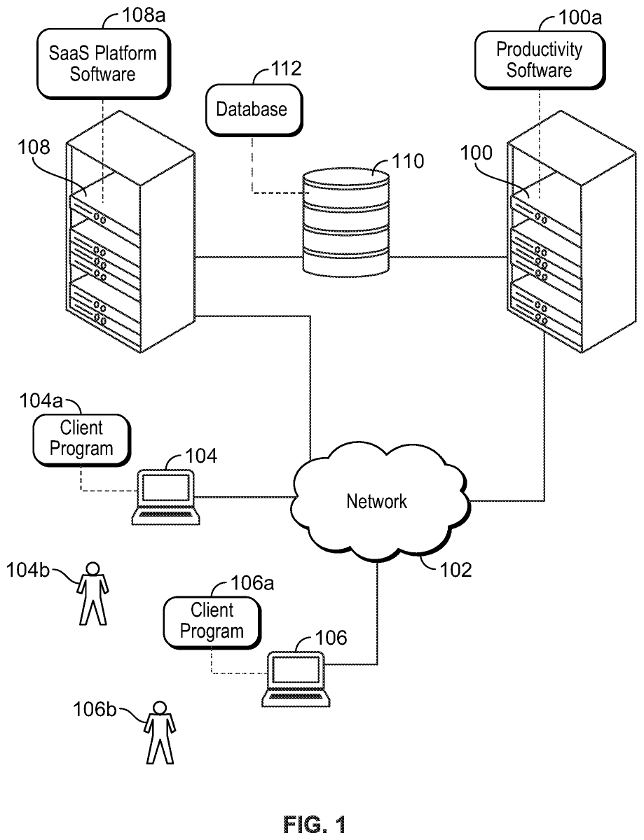

Various embodiments of the disclosure are implemented in a computer networking environment. Turning to FIG. 1, an example of such an environment is shown. A first computing device 100 (e.g., a hardware server or a cluster of hardware servers) is communicatively linked to a network 102. Possible implementations of the network 102 include a local-area network, a wide-area network, a private network, a public network (e.g., the Internet), or any combination of these. The network 102 may include both wired and wireless components. Also communicatively linked to the network 102 are a second computing device 104 (e.g., a client device), a third computing device 106 (e.g., a client device), and a fourth computing device 108 (e.g., a hardware server or a cluster of hardware servers).

It is to be understood that various embodiments may be carried out on the first computing device 100, the second computing device 104, the third computing device 106, or other computing devices not depicted, with one or both the second computing device 104 and the third computing device 106 accessing the first computing device 100 via client programs (labeled 104a and 106a, respectively), such as thin, web-based clients. In an embodiment, the first computing device 100 executes productivity software 100a (e.g., a document editing application, a spreadsheet application, etc.) and the fourth computing device 108 executes software-as-a-service (“SaaS”) platform software 108a. The first computing device 100 and the third computing device 108 are communicatively linked to a media storage device 110 (e.g., a memory or a redundant array of independent disks). Although FIG. 1 depicts the media storage device 110 as a single device, in fact, the media storage device 110 may be implemented as a single computing device or as multiple computing devices working together, and may represent a cloud storage service including multiple storage devices.

In another embodiment, the productivity software 100a and the SaaS platform software 108a execute on the same computing device (e.g., the first computing device 100 or the fourth computing device 108). For example, the productivity software 100a could reside on one partition of the first computing device 100 while the SaaS platform software 108a could reside on another partition of the first computing device 100. In other embodiments, portions of the productivity software 100a execute on both the first computing device 100 and the fourth computing device 108, and/or portions of the SaaS platform software 108a may be executed on both the first computing device 100 and the fourth computing device 108. With such network configurations, the second computing device 104 and the third computing device 106 are configured to access the computing device or devices on which the productivity software 100a resides.

Stored on the media storage device 110 is a database 112, which is maintained by the SaaS platform software 108a, but whose operations are controlled by the productivity software 100a, which issues instructions to read from, write to, and modify the contents of the database 112 via the SaaS platform software 108a.

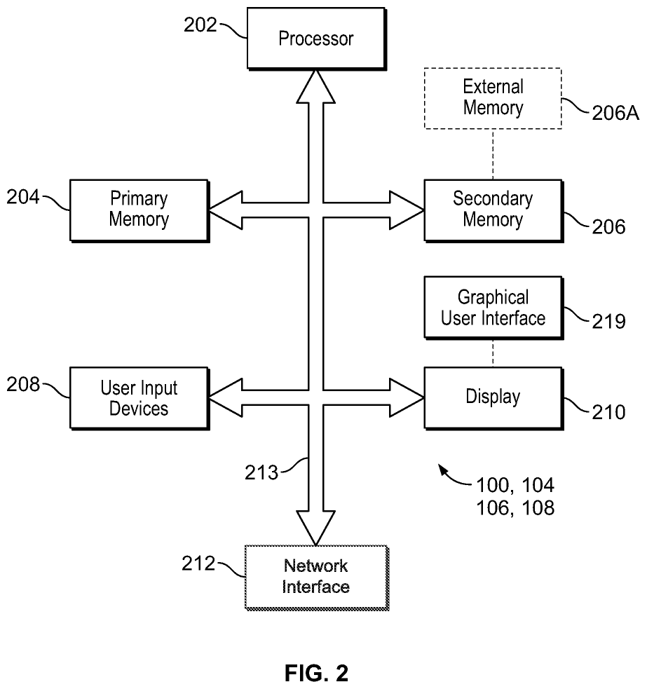

In one implementation, one or more of the computing devices of FIG. 1 (including the media storage device 110) have the general architecture shown in FIG. 2. The computing device of FIG. 2 includes processor hardware 202 (e.g., a microprocessor, controller, or application-specific integrated circuit) (hereinafter “processor 202”), a primary memory 204 (e.g., volatile memory, random-access memory), a secondary memory 206 (e.g., non-volatile memory), user input devices 208 (e.g., a keyboard, mouse, or touchscreen), a display device 210 (e.g., an organic, light-emitting diode display), and a network interface 212 (which may be wired or wireless). Each of the elements of FIG. 2 is communicatively linked to one or more other elements via one or more data pathways 213. Possible implementations of the data pathways 213 include wires, conductive pathways on a microchip, and wireless connections. In an embodiment, the processor 202 is one of multiple processors in the computing device, each of which is capable of executing a separate thread. In an embodiment, the processor 202 communicates with other processors external to the computing device in order to initiate the execution of different threads on those other processors.

Referring still to FIG. 2, the memories 204 and 206 store instructions executable by the processor 202 and data. The term “local memory” as used herein refers to one or both the memories 204 and 206 (i.e., memory accessible by the processor 202 within the computing device). In some embodiments, the secondary memory 206 is implemented as, or supplemented by an external memory 206A. The media storage device 110 is a possible implementation of the external memory 206A. The processor 202 executes the instructions and uses the data to carry out various procedures including, in some embodiments, the methods described herein, including displaying a graphical user interface 219. The graphical user interface 219 is, according to one embodiment, software that the processor 202 executes to display a report on the display device 210, and which permits a user to make inputs into the report via the user input devices 208.

This disclosure will sometimes refer to one or more of the client program 104a, the client program 106a, and the productivity software 100a as taking one or more actions. It is to be understood that such actions may involve only one of these software entities or may involve two or more. Possible ways that one or more of these programs could take an action include: (a) the client program transmitting hypertext transport protocol commands such as “Get” and “Post” in order to transmit to or receive information from the productivity software 100a (e.g., via a web server), and (b) the client program running a script (e.g., JavaScript) to send information to and retrieve information from the productivity software 100a. The productivity software 100a may ultimately obtain information (e.g., web pages or data to feed into plugins used by the client programs) from the database 112 or the SaaS platform software 108a.

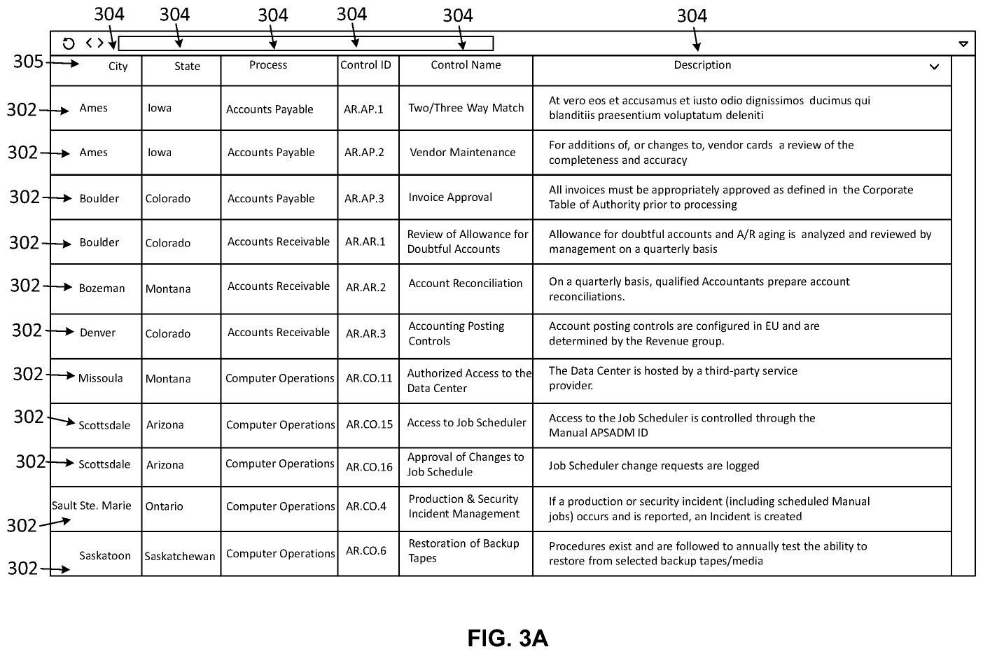

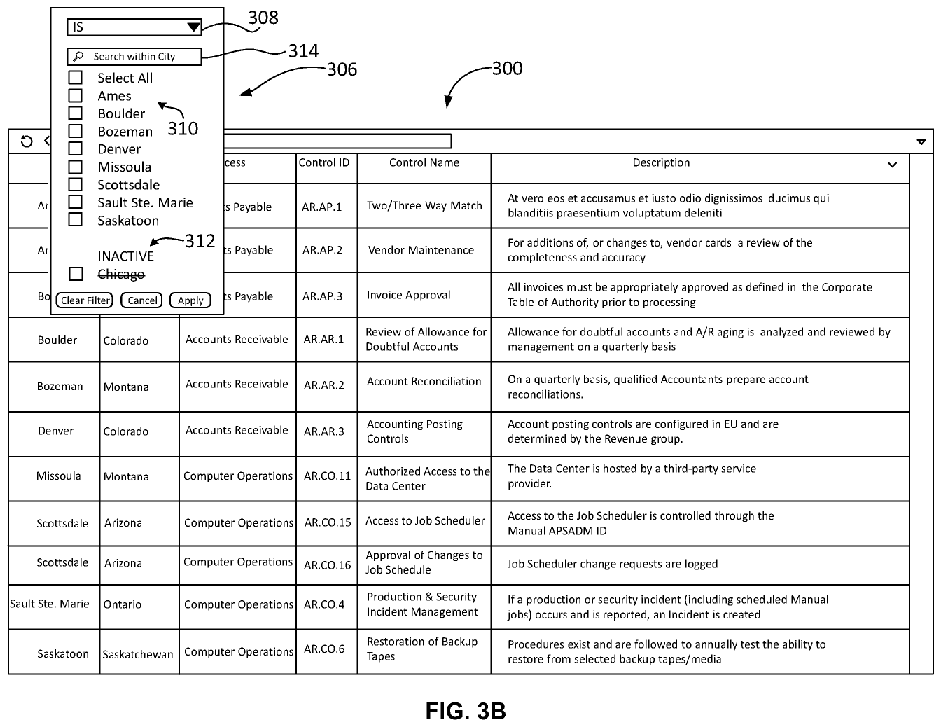

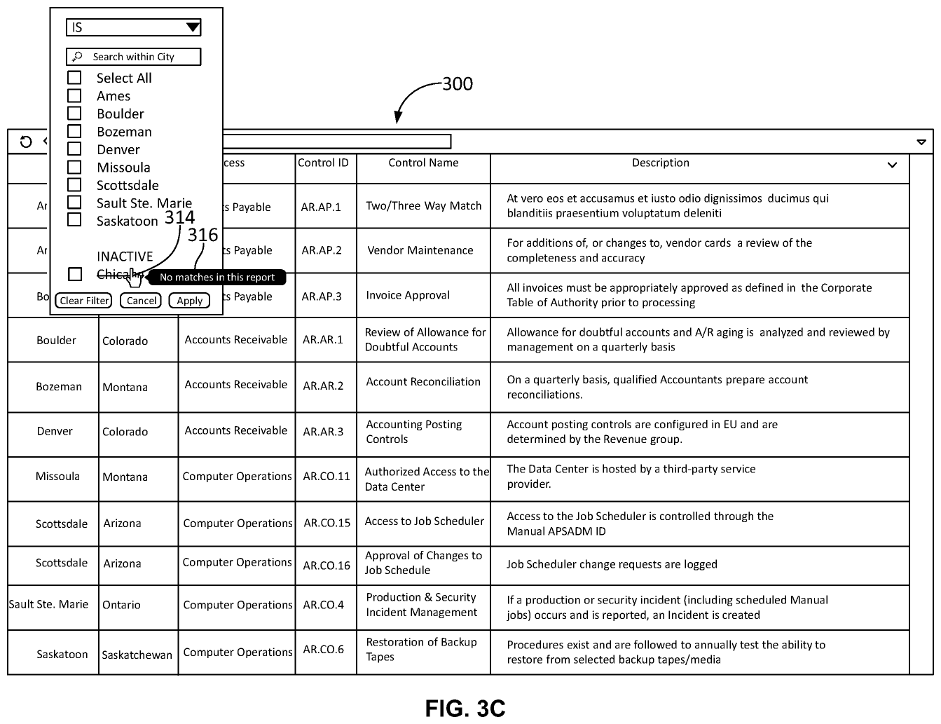

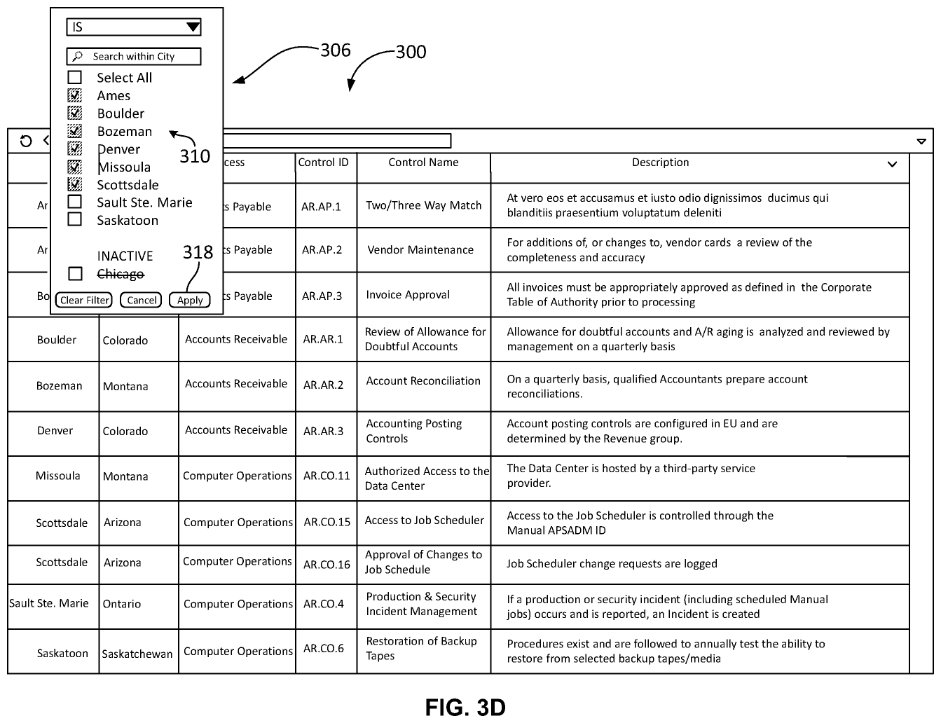

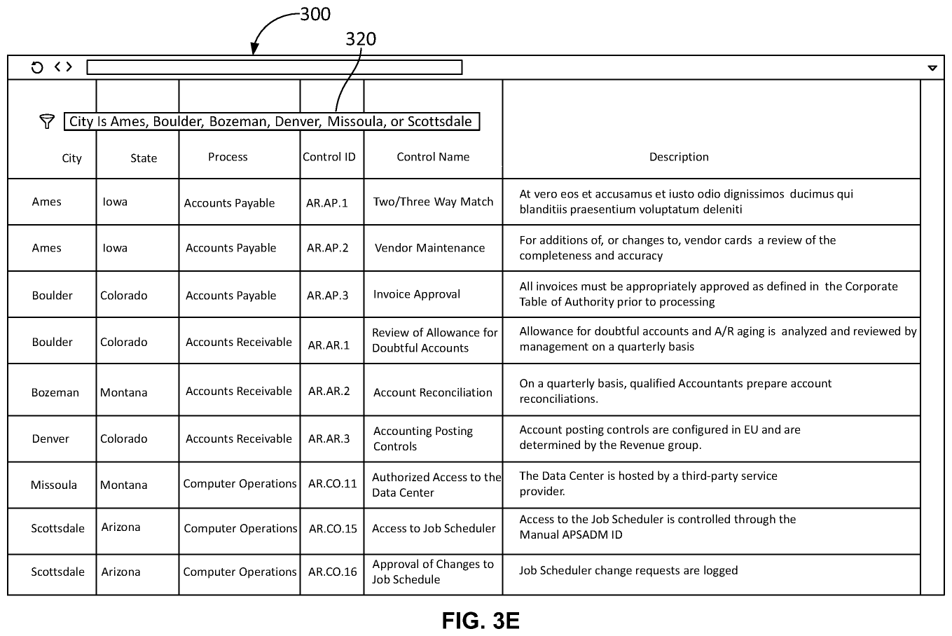

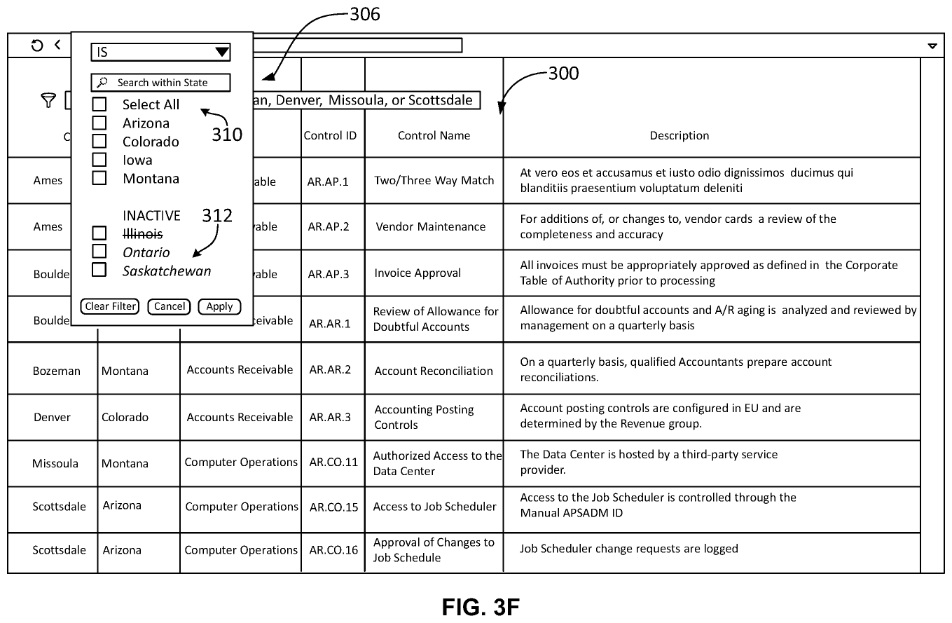

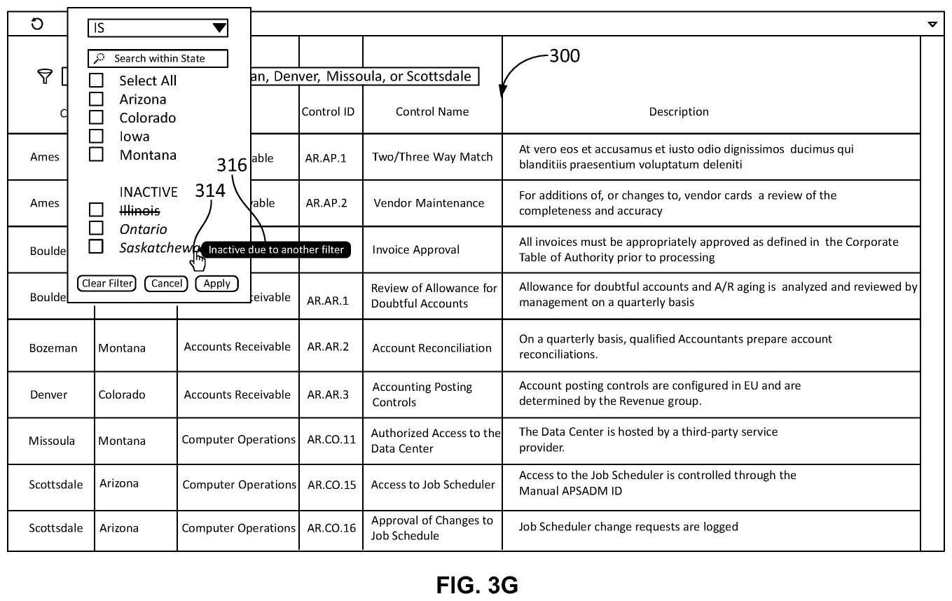

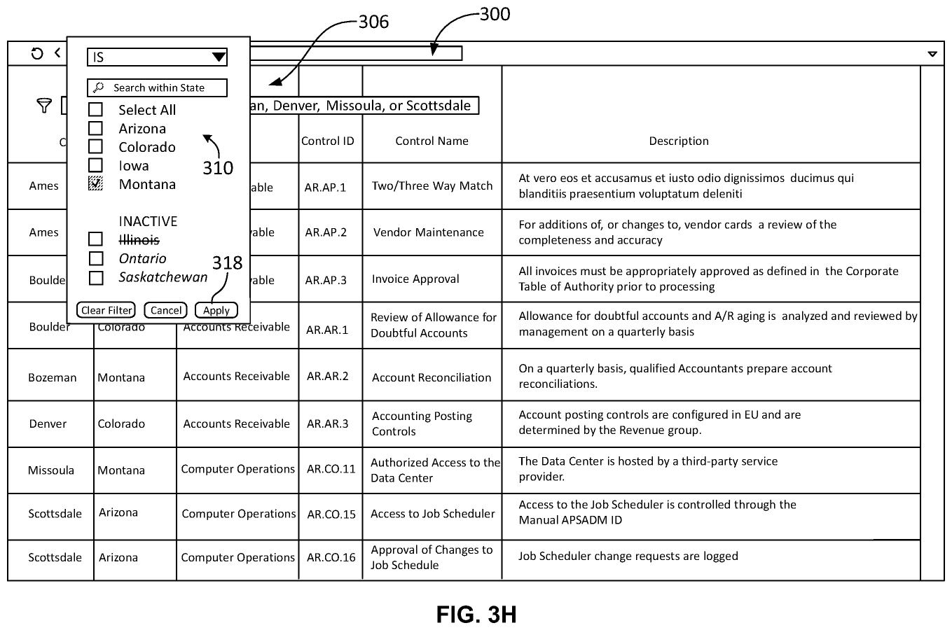

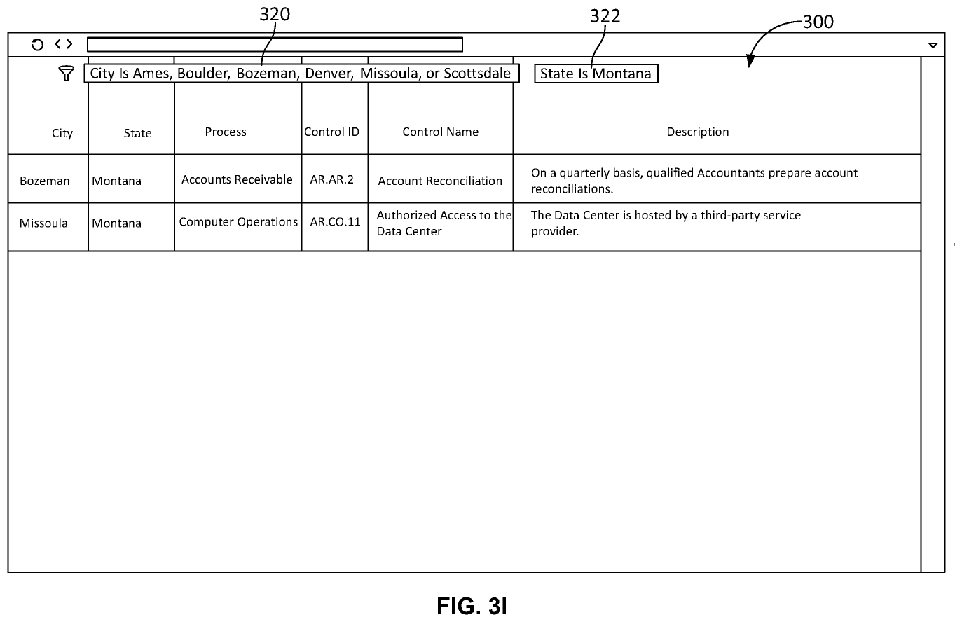

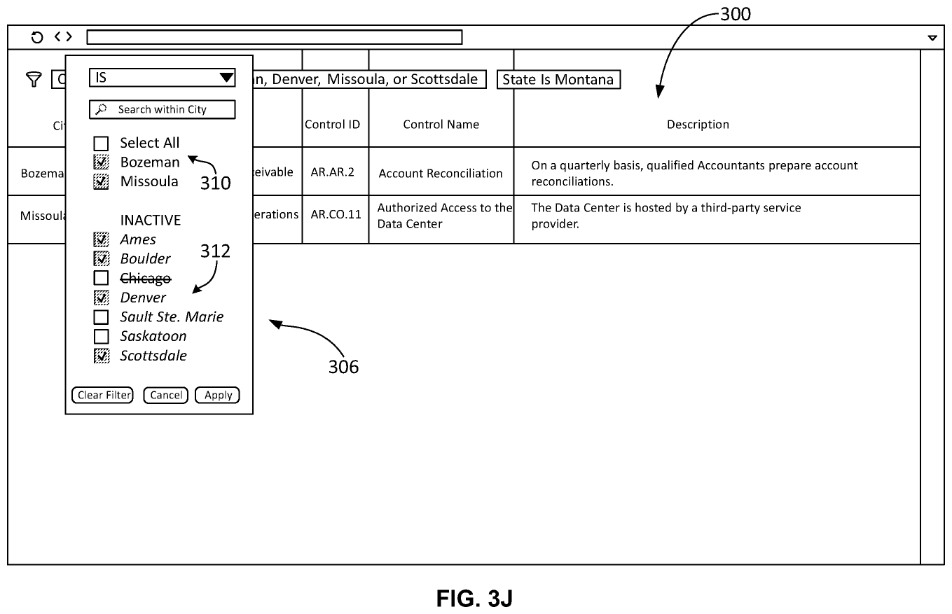

To help illustrate the various embodiment, assume that the first user 104b runs a report using a productivity software 100a. For example, the user 104b selects a report from a menu of the client program 104a, which sends the appropriate request to the productivity software 100a. The productivity software 100a responds by transmitting a previously-defined query to the SaaS platform software 108a, which responds by pulling the results from the database 112 and sending them back to the productivity software 100a. The productivity software 100a transmits the results to the client program, which displays the results to the first user 104b on the display 210 on a user interface. An example user interface 300 is shown in FIG. 3A. The user interface 300 displays a set of records as a table in the form of rows 302 and columns 304, in which each record is depicted as a row and each field within the record is depicted as a column of the row. The user interface 300 also includes a header row 305. Note that the records resulting from the search are considered to be the “displayed set” even if they are not all able to fit on the displayable area of the user interface 300 at the same time. For example, the displayed set may be scrollable if the number of records exceeds the size of the displayable area of the user interface 300.

In an embodiment, the user interface 300 permits a user to apply one or more filters to the set of records. In the example shown, each filter is specific to a type of field (e.g., specific to a particular column) and is made up of a logical statement (which may or may not include Boolean operators), such as “IS” or “IS NOT,” and a possible value for the field (e.g., where the possible values for a given field include all possible values for the field within the displayed set of records). The effect of applying a filter is to exclude (e.g., from the user interface) one or more records explicitly (e.g., through the use of an “IS NOT” operator) or implicitly (e.g., through the use of an “IS” filter), resulting in a subset of the set of records being displayed. In some embodiments, the application of a filter causes the query to be rerun with the filter applied. In other embodiments, the query is not rerun but only the displaying of the records is updated (with the removed records remaining available in local memory).

Turning to FIG. 3B, the user interface 300 further includes a filter creation tool 306 (e.g., displayed by the client program 104a in response to the appropriate user input, such as a “right click” on the appropriate header of the header row 305). The filter creation tool 306 includes an operator selection control 308 (a drop down list in this example), a list of filters including a list 310 of available filter values (i.e., a first sublist of the total filter list), and a list 312 of inactive (i.e., inapplicable) filter values (i.e., a second sublist of the total filter list). In this embodiment, a combination of an operator plus a filter value (i.e., the value of the field to be used in the filtering operation) constitutes a filter. As will be discussed in further detail below, multiple filters may be combined. Additionally, the filter creation tool 306 can be used to create multiple filters per field (e.g., per column).

In an embodiment, the user interface 300 visually indicates which filters (e.g., which operator/filter value combinations) are active (applicable to the record set) and which filters are inactive (not applicable to the records set). Furthermore, according to an embodiment, the user interface 300 visually indicates reasons for filters being inactive. For example, if the filter is currently inactive because the listed value is not within the set of records, then the listed value is shown with one type of appearance (e.g., grayed out font), whereas if the filter is unavailable because a previously applied filter has removed all records to which the listed value applies, then the listed value is shown with another type of appearance (e.g., grayed out font with strikethrough).

Additionally, for filters that are currently inactive because the listed value is not within the set of records, the appearance of the listed value for the filter may be different depending on whether the filter was used in the past (e.g., the listed value was previously in the set of records but has since been removed from the data set) or whether it has not been previously used. For example, assume that a query for all records for which the control ID is “AR.AP.1” was previously run, the records were displayed, and a filter for records whose City field was not equal to “Chicago” applied (resulting in the removal, from the display, of all “Chicago” records). Then, subsequently, all of the Chicago records were removed from the database (or their control ID fields were changed to something other than AR.AP.1). Further assume that, following this removal, the same query was re-executed to obtain an updated set of records. The user interface 300 would display the “Chicago” filter label in a way that visually indicates the fact that it no longer applies to the updated record set but was previously applied.

In a variation on the previous example, assume that the database did not include any records for which the “City” field was equal to Chicago, but that an administrator of the database knew that Chicago records would eventually be imported into the database. The administrator could (e.g., through an option provided by the filter creation tool 306) add a filter for the City field with the value “Chicago.” The Chicago filter would then be listed as “Inactive” with a visual indicator that indicates the reason for it being inactive (i.e., it applies to records that do not yet exist in the database).

According to an embodiment, the user interface 300 also visually indicates whether a given filter applies only to hidden data (e.g., only applies to data in hidden columns or rows). For example, if all records in a set (resulting from a particular query being run) for which the “City” field contains “Chicago” are hidden, then the filter for Chicago may be shown in a list of “Hidden” filters and/or shown with text of a distinct appearance.

In the example shown in FIG. 3B, the filter value “Chicago” is shown as being unavailable and in strikethrough font, indicating that a previous version of the report (i.e., a previous version of the set of records) contained at least one record having a “City” field with the value “Chicago,” but that no records in the current set have “Chicago” as a value for the city field. Other types of visual indicators are possible as well. For example, FIG. 3C depicts an embodiment in which a cursor 314 placed over “Chicago” results in hover text 316 stating that there are “No matches in this report.”

Turning to FIG. 3D, in an embodiment, it will be assumed that the user 104b selects (by checking the appropriate boxes) one or more filters of a first field—the City field, which is represented in the interface 300 by the City column. In this example, the user selects the following filters: City IS Ames, City IS Boulder, City IS Bozeman, City IS Denver, City IS Missoula, and City IS Scottsdale. The user 104b then clicks the Apply button 318. In response, the client program 104a and/or the productivity software 100a filters out (e.g., excludes, hides, or removes from the user interface 300) records (which are rows in this implementation) whose City field does not contain any of the values Ames, Boulder, Bozeman, Denver, Missoula, or Scottsdale. It should be noted that the interface for the filter creation tool 306 may be implemented with a simple checkbox list without an explicit operator selection menu. In such an implementation, checking a value (e.g., checking Ames, Boulder, etc.) may imply, for example, an “IS”.

According to an embodiment, upon application of the filters selected in FIG. 3D, the user interface 300 appears as shown in FIG. 3E, with the currently-applied filters shown in a filter bar 320. The records shown are a subset of the original set of records (i.e., the original set resulting from the database query).

Turning to FIG. 3F, assume that the user 104b would now like to filter the set of records by a second field—the State field, represented by the State column on the user interface 300. By carrying out the appropriate gesture on the user interface 300, the user 104b opens a filter creation tool 306 for the “State” field. Note that because the previously-applied filters for City excluded all records whose State did not include Arizona, Colorado, Iowa, and Montana, only the filters for Arizona, Colorado, Iowa, and Montana are available. The filters for Ontario and Saskatchewan are no longer available (due to the previous filters being applied), while the filter for Illinois does not apply to any record in the data set (since, in this example, the only records that had Illinois for a state were those having Chicago as a city). The user interface 300 visually indicates the unavailability of these filters. For example, in FIG. 3F, “Illinois” is in strikethrough font and “Ontario” and “Saskatchewan” are in italics. The user interface 300 may also indicate the nature of their unavailability using the hover function, as shown in FIG. 3G. As the hover text 316 indicates, the IS Saskatchewan filter is inactive due to the fact that another filter has been applied. In this example, any of the filters shown in the filter bar 320 would have caused the IS Saskatchewan filter to have become inactive.

In an embodiment, the user interface 300 not only indicates that a filter is inactive due to another filter having been applied, but also indicates which other filter is causing the inactive filter to be in the inactive status. For example, the hover text 316 in FIG. 3G might list all of the filters that would have cause the IS Saskatchewan filter to have become inactive.

Assume now that the user 104b wishes now to filter the records further by state-specifically limiting the records to those in which the State field contains the value “Montana.” The user 104b opens the filter creation tool 306 for the State field, as shown in FIG. 3H, checks the Montana box, and clicks the Apply button 316.

According to an embodiment, upon application of the filters selected in FIG. 3H, the user interface 300 appears as shown in FIG. 3I, with the newly-applied filters shown in second filter bar 322 alongside the filters shown in the first filter bar 320. Note that the corresponding filters for the City field (as well as filters for other fields for which all applicable records have been excluded) will also show as being inactive, as shown in FIG. 3J. Further note that filters that are shown as inactive may still be selected or unselected.

It should be understood that the exemplary embodiments described herein should be considered in a descriptive sense only and not for purposes of limitation. Descriptions of features or aspects within each embodiment should typically be considered as available for other similar features or aspects in other embodiments. It will be understood by those of ordinary skill in the art that various changes in form and details may be made therein without departing from their spirit and scope as set forth in the following claims. For example, the actions described herein can be reordered in ways that will be apparent to those of skill in the art.

What is claimed is:

1. A method for filtering a set of records on a user interface, the method comprising:
displaying a set of records, each record of the set comprising a first field and a second field;
removing, from the displayed set, one or more records according to a filter of the first field, thereby leaving a subset of the set of records displayed;
displaying filters for the second field; and
for at least one of the displayed filters, visually indicating that, due to a currently-applied filter, the at least one displayed filter does not apply to any of the records of the subset.

2. The method of claim 1, wherein displaying a set of records comprises displaying a table comprising a row for each record of the set, a first column for the first field and a second column for the second field.

3. The method of claim 1, further comprising receiving a user selection of the filter of the first field via a selection menu.

4. The method of claim 1, further comprising receiving a user selection of the filter of the first field;
launching a database query based on the filter of the first field; and
displaying the results of the query.

5. The method of claim 1, wherein visually indicating that, due to a currently-applied filter, the at least one displayed filter does not apply to any of the records of the subset comprises rendering the name of the at least one displayed filter in a font style, font color, or font size that is different from other displayed filters.

6. The method of claim 1, wherein visually indicating that, due to a currently-applied filter, the at least one displayed filter does not apply to any of the records of the subset comprises listing the at least one displayed filter in a first sublist that is distinct from filters that do apply to one or more records of the subset.

7. The method of claim 1, wherein removing, from the displayed set, one or more records according to a filter of the first field comprises removing, from the displayed set, all records whose first field contains a value specified by the filter.

8. The method of claim 1, wherein removing, from the displayed set, one or more records according to a filter of the first field comprises removing, from the displayed set, all records whose first field does not contain a text string specified by the filter.

9. The method of claim 1, further comprising visually indicating that the first filter is the currently-applied filter.

10. The method of claim 1, further comprising, for at least one of the displayed filters, visually indicating that rows containing records to which filter applies are hidden.

11. A method for filtering a set of records on a user interface, the method comprising:
executing a query of a database to obtain a set of records;
displaying the set of records;
applying a first filter to the displayed set of records;
removing, from the displayed set, all records to which the first filter applies;
re-executing the query of the database to obtain an updated set of records, wherein the updated set does not include any records to which the first filter would apply;
displaying a plurality of filter labels, including a label for the first filter; and
visually indicating that the first filter does not apply to any records of the set but has been previously applied.

12. The method of claim 11, wherein displaying a set of records comprises displaying a table comprising a row for each record of the set and a column for each field of the set of records.

13. The method of claim 11, further comprising receiving a user selection of the first filter via a selection menu.

14. The method of claim 11, wherein visually indicating that the first filter does not apply to any records of the set but has been previously applied comprises rendering the name of the first filter in a font style, font color, or font size that is different from other displayed filters.

15. The method of claim 11, wherein visually indicating that the first filter does not apply to any records of the set but has been previously applied comprises listing the filter in a first sublist that is distinct from filters that do apply to one or more records of the subset.

16. The method of claim 11, wherein visually indicating that the first filter does not apply to any records of the set comprises visually indicating that the first filter has been previously applied to a report generated using the query.

17. The method of claim 11, further comprising, for at least one of the displayed filters, visually indicating that, due to a currently-applied filter, at least one filter whose label is listed among the plurality of filter labels does not apply to any of the records of the subset.

18. A method for filtering a set of records on a user interface, the method comprising:
displaying a set of records, each record of the set comprising a first field and a second field;
receiving a user selection of a plurality of filters of the first field;
removing, from the displayed set, one or more records according to the plurality of filters, thereby leaving a subset of the set of records displayed;
displaying a plurality of filters for the second field; and
for at least one of the displayed filters of the second field, visually indicating that the displayed filter of the second field does not apply to any of the records of the subset due to a currently-applied filter,
wherein the currently-applied filter is a filter of the plurality of selected filters of the first field.

19. The method of claim 18, further comprising visually indicating which of the plurality of selected filters of the first field is the currently-applied filter.

20. The method of claim 18, wherein the displayed set of records is the result of a database query, the method further comprising:
receiving a user entry of a new filter that does not apply to any of the set of records; and
visually indicating that the new filter does not apply to any of the set of records.
